(19) United States
(12) Patent Application Publication
(10) Pub. No.: US 2013/0108972 A1
(43) Pub. Date: May 2, 2013

(54) SEPARATOR ASSEMBLY

(71) Applicants: Guido Stangherlin, Toowoomba (AU); Allan Douglas Bougoure, Toowoomba (AU)

(72) Inventors: Guido Stangherlin, Toowoomba (AU); Allan Douglas Bougoure, Toowoomba (AU)

(73) Assignee: AUSTRALIAN RIG CONSTRUCTION HOLDINGS PTY LTD, Toowoomba, QLD (AU)

(21) Appl. No.: 13/808,356

(22) PCT Filed: Jul. 15, 2011
(86) PCT No.: PCT/AU2011/000899

§ 371 Date: Jan. 4, 2013

(30) Foreign Application Priority Data
Jul. 16, 2010 (AU) 2010903174
Feb. 6, 2011 (AU) 2011900372

(51) Int. Cl. B01D 19/00; F23G 7/06

(52) U.S. Cl. CPC B01D 19/0052; F23G 7/06
USPC 431/202; 96/155; 96/216; 96/208; 96/209; 96/174; 96/219

(57) ABSTRACT

A separator assembly (1c) in the form of a flare tank for separating and igniting gas from non-gaseous components of a fluid stream (such as a well return). The separator assembly (1c) comprises: at least one degasser (4) having a fluid stream inlet (41) for introducing the fluid stream (well return) into a vessel (40) of the degasser (4) at a reduced velocity, and optionally a degasser gas pressure relief system (60) and non-gaseous component filter (40); a tank (3) having a settling compartment (30) and a suction compartment (31); and a flare (5c) for igniting gas leaving the degasser (4).

### FIELD OF THE INVENTION

This invention relates to a separator assembly for separating gas from a fluid stream. In one embodiment, the separator assembly is in the form of a flare tank comprising at least one degasser having a fluid stream inlet for introducing the fluid stream into a vessel of the degasser at a reduced velocity (and optionally comprising a degasser pressure relief system and non-gaseous component filter), a tank having a settling compartment and a suction compartment, and a flare for igniting gas leaving the degasser.

### BACKGROUND OF THE INVENTION

A flare tank is typically used for, but not limited to, well drilling and service operations and is utilised where a flammable gas returning to surface is likely. A flare tank is typically compact as it is designed to be moved from location to location by road transport. Existing designs for flare tanks cater for operations differing from Australian drilling practices where higher volumes of fluid stream returns, including a combination of formation fluid, fracturing sand and other solids, gas and air, are returned to surface during well servicing operations.

Well servicing is conducted subsequent to the drilling operation. The servicing operation uses compressed air which is used to force the fluid and solids to return to surface therefore cleaning the well out. The speed of which this is returned can vary and is difficult to control. The high volumes coupled with high velocity returns could adversely affect the successful operation of a common flare tank. This may occur by forcing fluid out a flare stack instead of exiting through a bottom of a degasser or by blowing out a fluid seal at the bottom of the degasser. Other adverse effects are premature wear of the degasser and mechanical damage from excessive forces. High volume of solids returns including fracturing sand could also gather inside the degasser thereby adversely affecting its operation.

In a typical flare tank a singular impingement separator, commonly known as a degasser, is fitted within a tank commonly known as a flare tank. Other common names include flow back tank and flare pit. The flare tank serves to collect liquids and entrained solids exiting the degasser which can then be recycled or discarded. The degasser takes inflow (ie. fluid stream) from a well through a flow line which is typically referred to as a blooie line. The blooie line is typically 150 mm nominal bore pipe and is connected to an oil or gas well through a mud cross. The blooie line typically enters directly into a separating vessel of the degasser with its bore diameter unchanged; fluids entering the degasser at speed flow across a void in the degasser vessel and strike an impingement plate. The degasser vessel also typically accepts up two additional smaller diameter inflows typically from a choke manifold and are typically up to 100 mm nominal bore.

The limitation of a typical flare tank as described above is that during operations common to Australian well servicing techniques sudden high flow rates of gas, mainly air, occur and force liquid that is both trapped in the air flow and stored in the flare tank through both openings at the top and bottom of a typical degasser vessel. A typical degasser is designed primarily to work with a constant flow rate returning from an oil or gas well, and this flow rate is either typically governed by a choke valve or the maximum flow rate of mud pumps.

### SUMMARY OF THE INVENTION

The inventors have designed a separator assembly for separating gas from other non-gaseous components of a fluid stream, such as a well return. However, it is to be understood that use of the separator assembly is not limited to well drilling and servicing operations.

The inventors have also designed a separator assembly capable of minimising one or more of the disadvantages mentioned above.

According to a first aspect of the present invention there is provided a separator assembly for separating gas from non-gaseous components of a fluid stream, said assembly comprising:

a degasser comprising:
a vessel;
a fluid stream inlet for introducing the fluid stream into the vessel;
an outlet for non-gaseous components of the fluid stream located at an lower end of the vessel; and
a gas outlet located at an upper end of the vessel.

According to a second aspect of the present invention there is provided a separator assembly for separating gas from non-gaseous components of a fluid stream, said assembly comprising:

a degasser comprising:
a vessel;
a fluid stream inlet connectable to a fluid stream line for introducing the fluid stream from the fluid stream line into the vessel at a reduced velocity relative to a velocity of the fluid stream within the fluid stream line;
an outlet for non-gaseous components of the fluid stream located at an lower end of the vessel; and
a gas outlet located at an upper end of the vessel.

According to a third aspect of the present invention there is provided a separator assembly for separating gas from non-gaseous components of a fluid stream, said assembly comprising:

a degasser comprising:
a vessel;
a fluid stream inlet for introducing the fluid stream into the vessel;
an outlet for non-gaseous components of the fluid stream located at an lower end of the vessel;
a gas outlet located at an upper end of the vessel; and
a pressure relief system for venting gas when gas pressure within the vessel exceeds a predetermined pressure.

According to a fourth aspect of the present invention there is provided a separator assembly for separating gas from non-gaseous components of a fluid stream, said assembly comprising:

a degasser comprising:
a vessel;
a fluid stream inlet for introducing the fluid stream into the vessel;
an outlet for non-gaseous components of the fluid stream located at an lower end of the vessel;
a gas outlet located at an upper end of the vessel; and
at least one filter for filtering out non-gaseous components entrained in the gas such that they cannot escape through the gas outlet.

According to a fifth aspect of the present invention there is provided a separator assembly for separating gas from non-gaseous components of a fluid stream, said assembly comprising:

a degasser comprising:
a vessel;
a fluid stream inlet for introducing the fluid stream into the vessel, wherein the fluid stream inlet is extendable and retractable relative to the vessel;
an outlet for non-gaseous components of the fluid stream located at an lower end of the vessel; and
a gas outlet located at an upper end of the vessel.

A detailed description of the features of the invention as defined in the first to fifth aspects follows.

### DETAILED DESCRIPTION OF THE INVENTION

The degasser can be of any suitable size, shape and construction, and can be made of any suitable material or materials. The degasser can separate gas from non-gaseous components (including mud, sand and liquid) of the fluid stream in any suitable way. For example, the degasser can be an impingement separator. Non-gaseous components can be separated from gas by way of gravity segregation and/or centrifugal action, for example. The degasser can be a poor boy separator. The degasser can be an open-bottom vertical mud gas separator and the outlet for non-gaseous components can be sealed by way of a liquid seal. The vessel can extend vertically such as for a vertical separator, or horizontally. Preferably, the vessel is cylindrical and vertically orientated, and is of sufficiently large diameter so as to handle large volumetric flow rates.

The outlet for non-gaseous components can be of any suitable size, shape and construction. In one embodiment the outlet for non-gaseous components is an opening in the lower end of the vessel. In another embodiment the outlet for non-gaseous components is a pipe or port extending from the vessel.

The gas outlet can be of any suitable size, shape and construction. In one embodiment the gas outlet is an opening in the upper end of the vessel. In another embodiment the gas outlet is a pipe or port extending from the vessel.

If the degasser is an impingement separator, the degasser can further comprise one or more impingement plates or baffles located within the vessel for effecting separation of gas from non-gaseous components as these move toward the lower end of the vessel. If employing centrifugal action, the degasser can comprise one or more baffles for disrupting swirling flow of the non-gaseous (fluid) components in the lower end of the vessel. The degasser can comprise internal baffle plates designed to change the direction of liquids and solids falling to the lower end of the vessel. The degasser can comprise a replaceable impingement plate held in position on the vessel using locators. The degasser can comprise a solids chute located at the lower end of the vessel and angled to direct solids away from the non-gaseous component outlet.

The degasser can comprise a flushing system located at the lower region of the vessel that can be used in conjunction with, but not limited to, the solids chute. The flushing system can comprise at least one jet of any suitable size, shape and construction, to force solids away from critical areas in the degasser.

The degasser can comprise a pressure relief system for venting gas when gas pressure within the vessel exceeds a predetermined pressure. The pressure relief system can be of any suitable size, shape and construction, and can be made of any suitable material or materials. The pressure relief system can be in the form of at least one valve, vent or flap. A vent or flap can be hinged to the vessel, and the vent or flap can move between an open gas-release position (when the gas pressure within the vessel exceeds the predetermined pressure) and a closed vessel-sealed position (when the vessel is not under excess pressure). Such a vent or flap preferably moves to the closed position due to gravity. In another embodiment, the pressure relief system can include a vent pipe for releasing vented gas at a safe distance from a flare or potential ignition source, or for conveying vented gas to a secondary degasser.

The separator assembly can comprise a flare for igniting gas escaping through the gas outlet. The flare can be of any suitable size, shape and construction, and can consist of any suitable material or materials.

The flare can comprise a flare stack and a pilot flame/line associated with the flare stack. In one embodiment, the flare stack can be in the form of a shroud that extends around the vessel and upwardly from the gas outlet, and the pilot flame can be located within the shroud. In another embodiment, the flare stack can be in the form of a pipe that extends sealingly from the gas outlet and the pilot flame is located at an end of that pipe remotely from the vessel such that any gas escaping the vessel other than via the pipe will not be ignited.

The degasser can comprise one or more filters (scrubbers) for filtering out any non-gaseous components (including liquids and particulates) entrained in the gas such that they cannot escape through the gas outlet. The filter can be of any suitable size, shape and construction, and can consist of any suitable material or materials. The filter can, for example, extend across the upper end of the vessel adjacent the gas outlet, pressure relief system and/or flare. An example of a suitable filter/scrubber is reinforced copper wool mesh (eg. 100 mm thick).

The fluid stream inlet that reduces the velocity of the fluid stream prior to entering the vessel can be of any suitable size, shape and construction. It can be connected to the vessel and fluid stream line in any suitable way—for example, welding, bolting, clamping, screwing or other suitable connecting arrangement.

Reducing the velocity of the fluid stream prior to entering the vessel can be achieved in any suitable way. Typically this will involve the fluid stream inlet being of greater diameter or cross-sectional area than the fluid stream line (blooie line), or a downstream (outflow) end of the fluid stream inlet being of greater diameter or cross-sectional area than an upstream (inflow) end of the fluid stream inlet. This change to a larger diameter/cross-sectional area will result in the fluid stream velocity slowing to a suitable flow speed. The change in diameter or cross-sectional area may be sudden or gradual over any given length of the fluid stream inlet. The diameter/cross-sectional area can be square, round, elliptical, oval or any other shape that may suit.

The fluid stream inlet can be extendable and retractable relative to the vessel so as to provide greater maneuverability when connecting to the fluid stream line.

The fluid stream inlet can be of unitary construction or can comprise two or more connected or connectable pipe (tubular) pieces. The fluid stream inlet can be of adjustable length. If two or more pipe (tubular) pieces, these can be connected together in any suitable way. Each piece pipe can be of a differing diameter. One or more pipe pieces can be tapered so as to provide a gradual change in diameter. If required, two or more of the pipe pieces can be telescopic such that the overall length of the inlet can be adjusted prior to or after connecting to a fluid stream line.

In one embodiment, the fluid stream inlet can be in the form of a port or connector extending from the vessel for connection to the fluid stream line either directly or via an adaptor. A fluid stream line having a diameter of, say, 150 mm, could be connected directly to such a port or connector. A fluid stream line having a diameter smaller than that of the port or connector could be connected to the port or connector via a diameter-increasing adaptor. In instances where a fluid stream line has been adapted with an adaptor to provide an enlarged diameter relative to a remainder of the line, that adaptor can form part of the fluid stream inlet. In practice, this may involve a fluid stream line being connected to, say, a 150 mm diameter adaptor.

The fluid stream inlet can feed the fluid stream into the vessel in any suitable way but preferably the fluid stream inlet feeds the fluid stream tangentially into the vessel such that centrifugal force separates the gas from the non-gaseous components of the fluid stream.

In one embodiment the fluid stream inlet comprises an inflow end connectable to a fluid stream line (blooie line) and an outflow end that is of greater diameter/greater cross-sectional area than the fluid stream inflow end. The cross-sectional areas can be square, round, elliptical, oval or any other shape that may suit. The cross-sectional area of the inflow can be a different shape from the cross-sectional area of the outflow end. In this way, as the fluid stream moves from the inflow end to the outflow end its velocity decreases, thus ultimately reducing the impact on the vessel and impingement plate.

The outflow end can feed the fluid stream tangentially into the vessel such that centrifugal force separates the gas from the non-gaseous components of the fluid stream, whereby the non-gaseous components fall by gravity to the outlet for non-gaseous components at the lower end of the vessel whilst gasses escape the vessel via the gas outlet. The outflow end can be connected to the vessel by welding, bolting, clamping or other suitable fixing arrangement.

The inflow end is connectable to the fluid stream line (blooie line) in any suitable way. The inflow end can be connected to the fluid stream line by welding, bolting, clamping or other suitable fixing arrangement. If desired, the inflow end can comprise at least one telescopic adapter pipe that is extendable and retractable relative to a remainder of the fluid stream inlet so as to provide greater maneuverability when connecting to the fluid stream line.

The inflow end can be designed so as to connect to the fluid stream line other than along a shared central longitudinal axis. For example, the fluid stream line can extend within the inflow end at an angle up to about seven degrees relative to the central longitudinal axis of the inflow end. Typically, the fluid stream line will be a six inch nominal bore blooie line.

In another embodiment the fluid stream inlet comprises (1) a pipe, tube or other type of vessel connector or port, and (2) at least one diameter-reducing adaptor at its inflow end for connection to a smaller diameter fluid stream line. An outflow end of the pipe or tube or other type of vessel connector can feed the fluid stream tangentially into the vessel. In this embodiment the pipe, tube or other type of vessel connector or port need not have inflow and outflow ends of differing diameter/cross-sectional area. What is important is that the outflow end is of larger diameter/cross-sectional area than the diameter of the fluid stream line so that the velocity of the fluid stream decreases prior to entering the vessel.

The separator assembly can further comprise a tank adapted to contain liquid and the lower end of the vessel can be located within the tank so that the outlet for non-gaseous components can be sealed with liquid and such that gas within the vessel is encouraged to escape the vessel through the gas outlet.

The tank can be of any suitable size, shape and construction, and can consist of any suitable material or materials. The tank can comprise one or more compartments, such as a settling compartment within which the lower end of the vessel is located, and a suction compartment that collects clarified liquid from the settling compartment (from which particulates have to some degree separated). The tank can have a metering v-weir for conveying liquid from the settling compartment to the suction compartment. The suction compartment can have a suction port for the removal of liquid from the suction compartment.

The separator assembly can comprise a framework and/or skid for supporting the tank and other components of the assembly and/or for transporting the assembly by road or rail. The framework or skid can have lifting fixtures for cranes and hoists. The framework or skid can have safety handrails, platforms etc.

The separator assembly can comprise more than one degasser, in which case the degassers can be connected to one another in a series. The degassers can be similar to one another and operate in a similar way or not. The degassers can each extend within a settling compartment of a tank.

The gas outlet of a first (primary) degasser can extend to a vessel of a second (secondary) degasser. The gas outlet of the primary degasser can be a pipe or duct of any suitable length and cross-section and can feed the gas/fluid stream tangentially into the vessel of the second degasser.

The primary degasser can have a pressure relief system located above the gas outlet of the primary degasser. The primary degasser can have a non-gaseous component filter or not.

Alternatively or additionally, a vent pipe of a pressure relief system of a primary degasser can extend to a vessel of a secondary degasser. The vent pipe of the primary degasser can be a pipe or duct of any suitable length and cross-section.

The separator assembly can be in the form of a flare tank.

According to a sixth aspect of the present invention there is provided a flare tank for separating and igniting gas from non-gaseous components of a fluid stream, said flare tank comprising:

at least one degasser having a fluid stream inlet for introducing the fluid stream into a vessel of the degasser at a reduced velocity, and optionally comprising a degasser pressure relief system and non-gaseous component filter;

a tank having a settling compartment and a suction compartment; and

a flare for igniting gas leaving the degasser.

According to a seventh aspect of the present invention there is provided flare tank for separating and igniting gas from non-gaseous components of a fluid stream, said flare tank comprising:

at least one degasser having a fluid stream inlet connectable to a fluid stream line for introducing the fluid stream from the fluid stream line into the vessel at a reduced velocity relative to a velocity of the fluid stream within the fluid stream line, and optionally comprising a degasser gas pressure relief system and non-gaseous component filter;

a tank having a settling compartment and a suction compartment; and

a flare for igniting gas leaving the degasser.

The flare tank according to the sixth and seventh aspects can have one or more features as described above in respect of the first to fifth aspects.

Preferred embodiments of the invention will now be described, by way of example, with reference to the accompanying figures.

### BRIEF DESCRIPTION OF THE FIGURES

FIG. 1 is an isometric view of a separator assembly according to an embodiment of the present invention.

FIG. 2 is an isometric view of a separator assembly (flare tank) similar to the assembly of FIG. 1, according to another embodiment of the present invention.

FIG. 3 is an isometric view of a separator assembly (flare tank) similar to the assembly of FIG. 1, according to another embodiment of the present invention.

FIG. 4 is an isometric view of a separator assembly (flare tank) similar to the assembly of FIG. 3, according to another embodiment of the present invention.

FIG. 5 is an isometric view of a separator assembly (flare tank) according to another embodiment of the present invention.

FIG. 6 is a partial cross-sectional view of the separator assembly shown in FIG. 5.

FIG. 7 is an isometric view of a separator assembly (flare tank) according to another embodiment of the present invention.

FIG. 8 is a partial cross-sectional view of the separator assembly shown in FIG. 7.

### DESCRIPTION OF THE PREFERRED EMBODIMENTS

In the figures like reference numerals refer to like features.

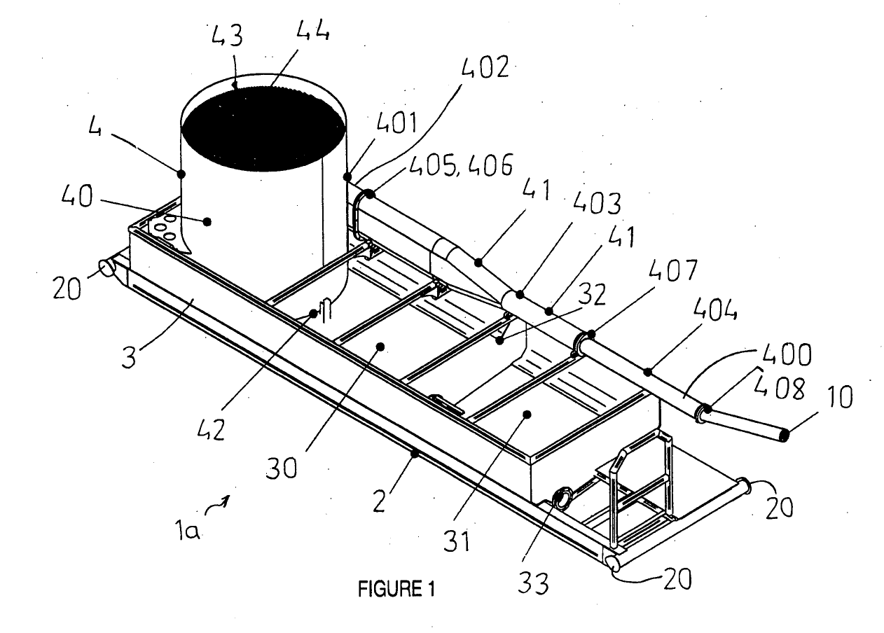

Referring first to FIG. 1, there is shown a separator assembly 1a for separating gas from non-gaseous components of a fluid stream (well returns). The separator assembly 1a comprises a skid/framework 2, a tank 3 and a degasser 4.

The skid/framework 2 enables the assembly 1a to be lifted and transported by rail or road. A lifting fixture 20 is located at each corner of the skid/framework 2.

The tank 3 is supported by the skid/framework 2 and comprises a settling compartment 30 and a suction compartment 31. These compartments 30, 31 have a common wall having a metering v-weir 32 such that liquid can flow from the settling compartment 30 to the suction compartment 31. The suction compartment 31 has a suction port 33 through which liquid can be removed/pumped.

The degasser 4 is an impingement separator comprising a cylindrical vessel 40, a fluid stream inlet 41 for introducing the fluid stream into the vessel 40 at a greatly reduced velocity, a non-gaseous component outlet 42 located at a lower end of the vessel 40, a gas outlet 43 located at an upper end of the vessel 40, and a filter 44 extending across the upper end of the vessel 40.

The vessel 40 can have a diameter of about 2200 mm and a volume of about 6.3 m³.

The lower end of the vessel 40 extends within the settling compartment 30. The non-gaseous component outlet 42 is an opening in the lower end of the vessel 40 and is effectively sealed when the settling compartment 30 contains liquid. When sealed with liquid, any gas within the vessel 40 escapes the vessel 40 via the gas outlet 43.

The gas outlet 43 corresponds to an open upper end of the cylindrical vessel 40 and is situated above the fluid stream inlet 41.

The filter/scrubber 44 (reinforced copper wool mesh) extends across the upper end of the vessel 40 and can capture non-gaseous components of the fluid stream (including liquids and particulates) entrained in the escaping gas.

Although not shown, the degasser 4 also comprises an impingement plate within the vessel 40 and baffles for disrupting swirling flow of non-gaseous components in the lower end of the vessel 40 (not shown).

As mentioned, the fluid stream inlet 41 reduces the velocity of the fluid stream prior to entering the vessel 40. The fluid stream inlet 41 comprises an inflow end 400 connectable to a fluid stream line 10 (blooie line 10) and an outflow end 401 that is of greater diameter/greater cross-sectional area than the inflow end 400. In this way, as the fluid stream moves from the inflow end 400 to the outflow end 401, its velocity decreases, thus ultimately reducing the impact force on the vessel 40 and its impingement plate.

The outflow end 401 introduces the fluid stream tangentially into the vessel 40 such that centrifugal force separates the gas from the non-gaseous components of the fluid stream, whereby the non-gaseous components fall by gravity to the non-gaseous component outlet 42 whilst gasses escape the vessel 40 via the gas outlet 43.

As seen in FIG. 1, the fluid stream inlet 41 comprises a first pipe 402 of large diameter/cross-sectional area, a second pipe 403 of reducing diameter/cross-sectional area, and a third telescopic adapter pipe 404 that is connectable to a blooie line 10. The first pipe 402 provides the outflow end 401 and is welded to the vessel 40. The inflow end 400 is provided by the second 403 and third 404 pipes. A flanged end 405 of the first pipe 402 is connected to a flanged end 406 of the second pipe 403. The third telescopic adapter pipe 404 has a first end that extends within the second pipe 403 and a second end that connects to the blooie line 10. The first end is held in position within the second pipe 403 by way of a union 407. The second end of the third telescopic adapter pipe 404 is also connected to the blooie line 10 by way of a union 408. The union 408 enables the blooie line 10 to be connected up to about seven degrees (offset) relative to a central longitudinal axis of the third telescopic adapter pipe 404.

In use, a fluid stream from a well (well return) flows from the blooie line 10 within the fluid stream inlet 41 and into the vessel 40. Due to the increasing diameter/cross-sectional area of the fluid stream inlet 41, the fluid stream enters at a greatly reduced velocity (relative to its velocity within the blooie line 10) tangentially into the vessel 40 and flows in a spiral motion within the vessel 40. As a result of centrifugal forces, the non-gaseous components (ie. liquids and entrained particulates) spiral downwards until exiting through the non-gaseous component outlet 42 into the settling compartment 30 of the tank 3. Gases that separate from the fluid stream pass through the non-gaseous component filter 44 located at the upper end of the vessel 40 and further through the gas outlet 43.

Solids settle at the bottom of the settling compartment 30 while clarified liquid flows through the metering v-weir 32 into the suction compartment 31. Liquid is then pumped out of the suction compartment 31 via the suction point 33.

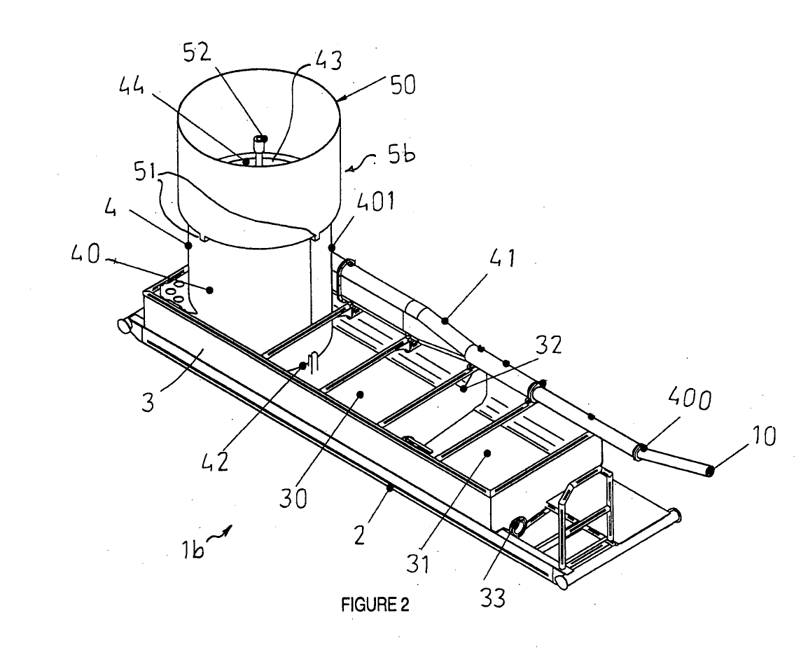

Referring now to FIG. 2, there is shown a separator assembly 1b like the separator assembly 1a of FIG. 1 except that it further comprises a flare 5b. The flare 5b is used to ignite separated flammable gas of the fluid stream.

The flare 5b comprises a flare stack 50 in the form of a shroud 50 that extends around and upwardly from the vessel 40. The flare stack 50 rests atop the vessel 40 by way of radial stays 51 that extend between a wall of the flare stack 50. The flare 5b further comprises a pilot flame 52 extending centrally within the shroud 50 and the pilot flame 52 is supported by the radial stays 51. The pilot flame 52 is protected from wind by the shroud 50.

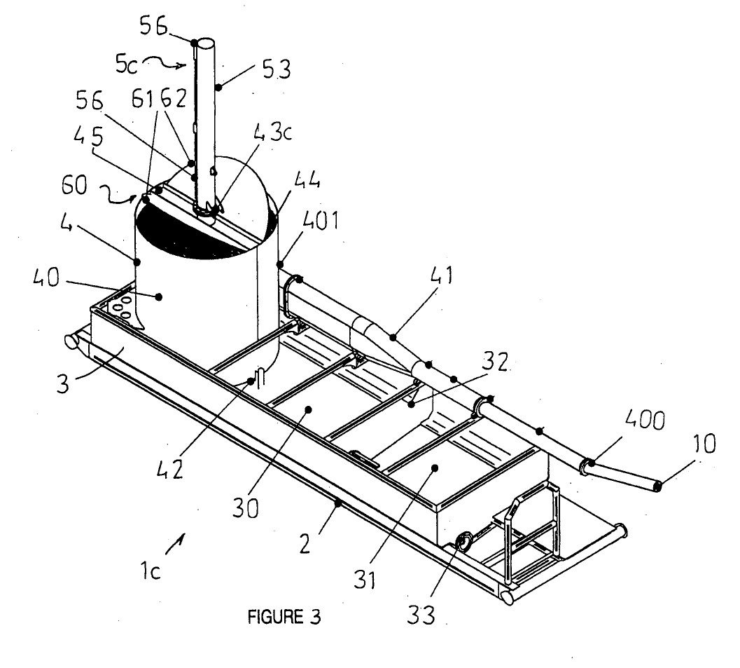

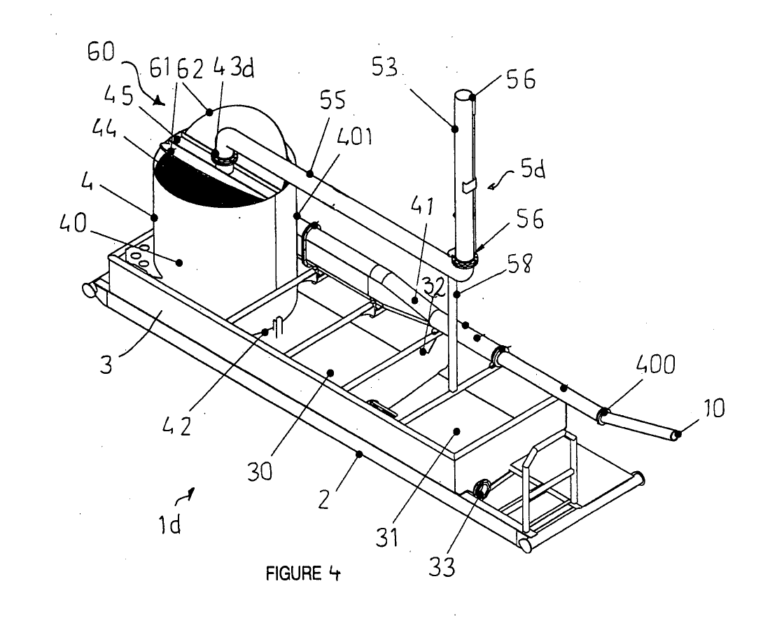

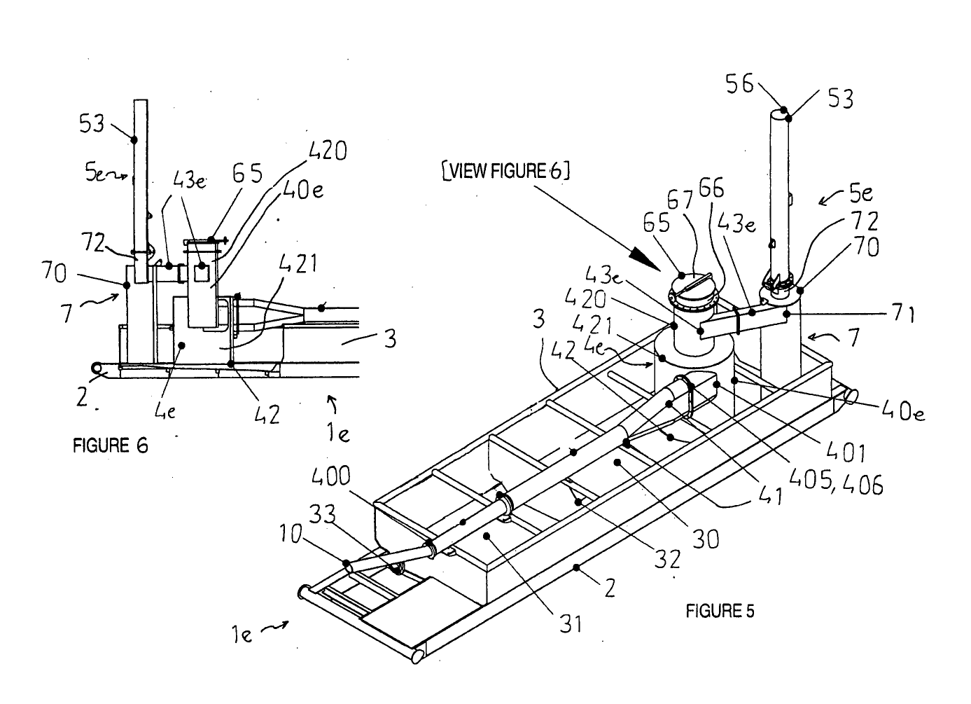

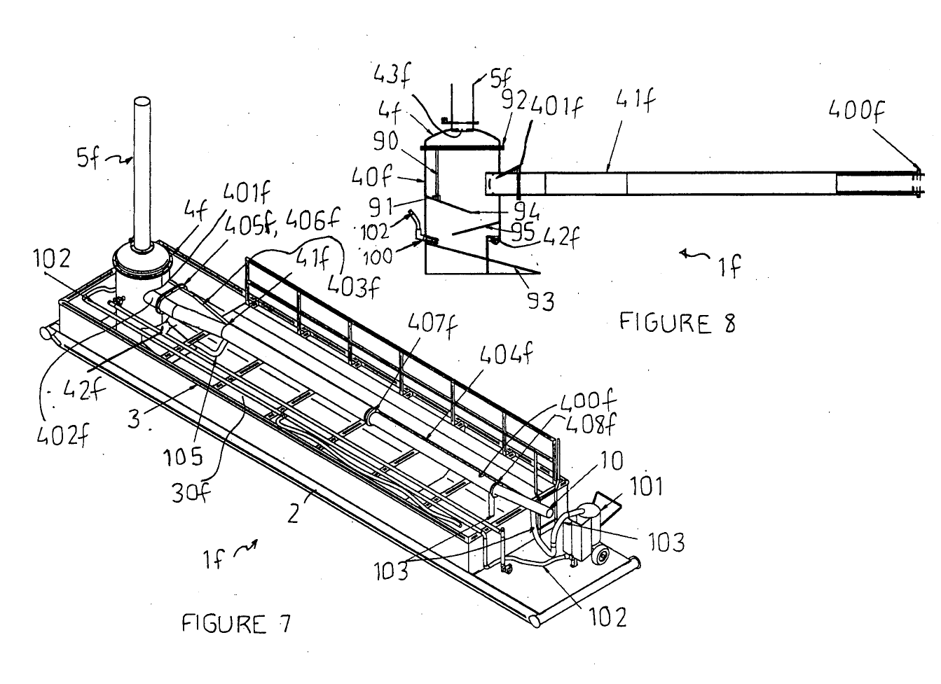

Referring now to FIG. 3, there is shown a separator assembly 1c like the separator assembly 1b of FIG. 2 except that it comprises a different type of flare 5c.

In this instance, the flare 5c comprises a flare stack 53 comprising a flanged pipe 53 that extends from the upper end of the vessel 40. A radial crosspiece 45 of the degasser 4 extends across the upper end of the vessel 40 and the gas outlet 43c extends centrally from the radial crosspiece 45. A flanged end of the flare stack pipe 53 is connected to a flanged end of the gas outlet 43c. The flare 5c further comprises a pilot flame/line 56 that extends along the flare stack pipe 53.

The separator assembly 1c of FIG. 3 further differs from the assemblies 1a, 1b of FIGS. 1 and 2 in that its degasser 4 has a pressure relief system 60 for venting gas when gas pressure within the vessel 40 exceeds a predetermined pressure. The pressure relief system 60 is in the form of a pair of vents 61, 62 hinged to each longitudinal side of the radial crosspiece 45.

Each vent 61, 62 can move between an open gas-release position (as shown in the figure) and a closed vessel-sealed position (when the vessel is no longer under excess pressure). Each vent 61, 62 moves to the closed position due to gravity.

During operations where the gas flow is constant the high flow pressure vents 61, 62 remain closed and all gas is forced out through to the flare stack 53. Exiting gases are then ignited by the pilot flame 56. During operations where the gas flow is excessive, the high flow pressure relief vents 61, 62 open (as shown) and release excess gas to atmosphere.

Referring now to FIG. 4, there is shown a separator assembly 1d like the separator assembly 1c of FIG. 3 except that it comprises a different sort of flare 5d.

The flare 5d comprises a flare stack 53 and a pilot flame/line 56. The flare stack 53 comprises a flanged upright pipe 53 that is connected to the flanged end of the gas outlet 43d by way of a flanged transfer pipe 55. That is, the transfer pipe 55 conveys gas through to the upright pipe 53 of the flare stack 53 for ignition by the pilot flame 56.

The flare 5d includes a T-shaped structural support 58 that extends across the suction compartment 31 and further to the flare stack 53.

During operations where the gas flow is constant the high flow pressure vents 61, 62 remain closed and all gas is forced out through to the flare stack 53. Exiting gases are then ignited by the pilot flame 56. During operations where the gas flow is excessive the high flow pressure relief vents 61, 62 open (as shown) and release the excess gases to atmosphere at a safe distance from the pilot flame 56.

Referring now to FIGS. 5 and 6, there is shown separator assembly 1e like the separator assemblies 1c, 1d of FIGS. 3 and 4 except that it further comprises a secondary degasser 7.

A primary degasser 4e of the assembly 1e of FIGS. 5 and 6 is like the other described degassers 40a-40d except that an upper region 420 of the vessel 40e is of smaller diameter than a lower region 421 of the vessel 40e. This upper region 420 of the vessel 40e has a round side wall from which extends a gas outlet 43e. A top of the upper region 420 is flanged and is connected to a pressure relief system 65.

The pressure relief system 65 comprises a flanged pipe 66 to which is hinged a vent lid 67 that can move (lift) to an open gas-venting position against the force of gravity.

The gas outlet 43e of the primary degasser 4e is a box-section duct 43e that conveys gas/fluid stream into a vessel 70 of the secondary degasser 7 at a location designated by numeral 71. The secondary degasser 7 functions similarly to the primary degasser 4e in that it has a lower vessel 70 end located within the settling compartment 30 and the lower end has a non-gaseous component outlet 42. The secondary degasser 7 has a gas outlet 72 extending upwardly from a top wall of the vessel 70.

The separator assembly 1e comprises a flare 5e comprising a flare stack 53 and a pilot flame 56. The flare stack 53 comprises an upright pipe 53 having a flanged end that is connected to a flanged end of the gas outlet 72 of the secondary degasser 7. The flare stack 53 conveys gas from the vessel 70 of the secondary degasser 7 to the pilot flame 56.

In use, gas which may also include entrained non-gaseous components of the fluid stream that is not successfully separated in the primary degasser 4e exits through the gas outlet 43e to the secondary degasser 7. The gas outlet duct 43e is tangentially connected to the upper region of the vessel 420 and tangentially to the secondary degasser vessel 70 (at numeral 71). Gas entering the secondary degasser 7 is separated as per the same process as the primary degasser 4e. Exiting gas escapes though the flare stack 53 located atop the secondary degasser 7 where it is ignited by the pilot flame 56.

Momentary high flow rates may be encountered during operations which exceed the capability of the secondary degasser 7. This excess in flow rate is released through the high flow rate pressure vent 65. The vent lid 67 of the high flow pressure vent 65 is hinged so that it automatically closes once the flow rate is reduced and resets to its normally closed position atop the flanged pipe 66 (as shown in FIG. 5).

When used in series, a filter 44 can still be used but is not necessarily required. Under normal relatively low flow rates the primary degasser 4e is not in its most efficient working range. To counter this inefficiency the outflow from the primary degasser 4e is fed into a secondary degasser 7. The primary degasser 4e is fitted with the above mentioned high flow pressure relief vent 65 on top above the filter 44. At the instant where flow rate is high the primary degasser 4e is working within its most efficient zone thus effectively separating non-gaseous components from the gas and allowing substantially clean gas to escape through the high flow vent 67.

Referring now to FIGS. 7 and 8, there is shown separator assembly 1f like the separator assembly 1c of FIG. 3 except that it has a modified degasser 4f.

The degasser 4f is an impingement separator comprising a cylindrical vessel 40f having a sealed upper end, a fluid stream inlet 41f for introducing the fluid stream into the vessel 40f at a reduced velocity, a non-gaseous component outlet 42f located at a lower end of the vessel 40f, and a gas outlet 43f located at the upper sealed end of the vessel 40f.

The lower end of the vessel 40f extends within the settling compartment 30f of the tank 3. The non-gaseous component outlet 42f is an opening in the lower end of the vessel 40f and is effectively sealed when the settling compartment 30f contains liquid. When sealed with liquid, any gas within the vessel 40f escapes the vessel 40f via the gas outlet 43f.

The fluid stream inlet 41f reduces the velocity of the fluid stream prior to entering the vessel 40f. The fluid stream inlet 41f comprises an inflow end 400f connectable to a blooie line 10 and an outflow end 401f that is of greater diameter/greater cross-sectional area than the inflow end 400f. In this way, as the fluid stream moves from the inflow end 400f to the outflow end 401f, its velocity decreases, thus ultimately reducing the impact force on the degasser 4f.

The fluid stream inlet 41f comprises a first pipe 402f of large diameter/cross-sectional area, a second pipe 403f of reducing diameter/cross-sectional area, and a third telescopic adapter pipe 404f that is connectable to the blooie line 10. The first pipe 402f provides the outflow end 401f and is welded to the vessel 40f. The inflow end 400f is provided by the second 403f and third 404f pipes. A flanged end 405f of the first pipe 402f is connected to a flanged end 406f of the second pipe 403f. The third telescopic adapter pipe 404f has a first end that extends within the second pipe 403f and a second end that connects to the blooie line 10. The first end is held in position within the second pipe 403f by way of a union 407f. The second end of the third telescopic adapter pipe 404f is also connected to the blooie line 10 by way of a union 408f.

As shown in FIG. 8, the degasser 4f comprises an impingement plate 90 within the vessel 40f. The impingement plate 90 is removable and is held in position by a wall of the vessel 40f and a retainer bracket 91. The impingement plate 90 can be accessed by removing a flanged upper end section 92 of the vessel 40f.

The degasser 4f comprises a solids chute 93 and a pair of baffle plates 94, 95 extending from the vessel 40f between the solids chute 93 and the impingement plate 90. The solids chute 93 is angled so that solids and liquids travel down the baffle plates 94, 95 and out of the vessel 40f via opening 42f, and further into the settling compartment 30f.

The degasser 4f also comprises a flushing system. The flushing system comprising a jet 100 is directed so that fluid pumped through the jet 100 forces any solids caught on the solids chute 93 through the opening 42f and into the settling compartment 30f. The flushing system is fed fluid from a pump 101 through a supply line 102. The pump 101 can recycle liquid from the tank 3 through suction line 103 or use liquid from another source. Solids collected in the settling compartment 30f can be pumped away using the pump 101 and flexible suction section 105 or by other pumping methods.

This embodiment caters for high solids content and high flow rate returns by reducing the speed of the fluid stream, allowing for the replacement of the impingement plate 90, directing solids away from the lower end of the degasser 4f by design of the solids chute 93 and by incorporating the flushing system to displace any solids lodged in the vessel 40f.

Whilst the above has been given by way of illustrative example of the invention, many modifications and variations may be made thereto by persons skilled in the art without departing from the broad scope and ambit of the invention as herein set forth.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

1. A separator assembly for separating gas from non-gaseous components of a fluid stream, said assembly comprising:
a degasser comprising:
a vessel;
a fluid stream inlet for introducing the fluid stream into the vessel;
an outlet for non-gaseous components of the fluid stream located at an lower end of the vessel; and
a gas outlet located at an upper end of the vessel.

2. The separator assembly of claim 1, wherein the degasser is an open-bottom vertical centrifugal separator and the outlet for non-gaseous components is sealed by way of a liquid seal.

3. The separator assembly of claim 1, wherein the fluid stream inlet is connectable to a fluid stream line for introducing the fluid stream from the fluid stream line into the vessel at a reduced velocity relative to a velocity of the fluid stream within the fluid stream line.

4. The separator assembly of claim 3, wherein the fluid stream inlet is of greater diameter or cross-sectional area than the fluid stream line.

5. The separator assembly of claim 1, wherein the fluid stream inlet is extendable and retractable relative to the vessel.

6. The separator assembly of claim 1, wherein the fluid stream inlet feeds the fluid stream tangentially into the vessel.

7. The separator assembly of claim 1, wherein the degasser comprises a pressure relief system for venting gas when gas pressure within the vessel exceeds a predetermined pressure, and, optionally, the pressure relief system is in the form of a vent or flap hinged to the vessel, and the vent or flap can move between an open gas-release position and a closed vessel-sealed position.

8. (canceled)

9. The separator assembly of claim 1 further comprising a flare comprising a flare stack and a pilot flame for igniting gas escaping through the gas outlet.

10. The separator assembly of claim 9, wherein: the flare stack is in the form of a shroud that extends around the vessel and upwardly from the gas outlet, and the pilot flame is located within the shroud; or, the flare stack is in the form of a flare pipe that extends sealingly from the gas outlet and the pilot flame is located at an end of the flare pipe remotely from the vessel such that flammable gas escaping the vessel other than via the flare pipe will not be ignited.

11. (canceled)

12. The separator assembly of claim 1, wherein the degasser comprises at least one filter for filtering out non-gaseous components entrained in the gas such that they cannot escape through the gas outlet, and, optionally, the filter extends across the upper end of the vessel adjacent the gas outlet.

13. (canceled)

14. The separator assembly of claim 1, wherein the fluid stream inlet comprises an inflow end connectable to a fluid stream line and an outflow end that is of greater diameter or greater cross-sectional area than the fluid stream inflow end or a diameter of the fluid stream line.

15. The separator assembly of claim 14, wherein the outflow end feeds the fluid stream tangentially into the vessel.

16. The separator assembly of claim 14, wherein the inflow end comprises at least one telescopic adapter pipe that is extendable and retractable relative to a remainder of the fluid stream inlet so as to provide greater maneuverability when connecting to the fluid stream line.

17. The separator assembly of claim 14, wherein the inflow end is designed so as to connect to the fluid stream line other than along a central longitudinal axis of the telescopic adapter pipe.

18. The separator assembly of claim 1 further comprising a tank adapted to contain liquid and the lower end of the vessel is located within the tank so that the outlet for non-gaseous components is sealed with liquid.

19. The separator assembly of claim 18, wherein the tank comprises a settling compartment within which the lower end of the vessel is located, and a suction compartment that collects clarified liquid from the settling compartment.

20. The separator assembly of claim 19, wherein the tank comprises a metering v-weir for conveying liquid from the settling compartment to the suction compartment.

21. The separator assembly of claim 1 further comprising a framework and/or skid.

22. The separator assembly of claim 1 further comprising a secondary degasser, and the gas outlet of a primary said degasser extends to a vessel of the secondary degasser.

23. A flare tank for separating and igniting gas from non-gaseous components of a fluid stream, said flare tank comprising:
at least one degasser having a fluid stream inlet connectable to a fluid stream line for introducing the fluid stream from the fluid stream line into a vessel of the degasser at a reduced velocity relative to a velocity of the fluid stream within the fluid stream line, and optionally comprising a degasser gas pressure relief system and non-gaseous component filter;
a tank having a settling compartment and a suction compartment; and
a flare for igniting gas leaving the degasser.

24. (canceled)
